(19) United States
(12) Patent Application Publication
(10) Pub. No.: US 2013/0213118 A1
(43) Pub. Date: Aug. 22, 2013

(54) FUEL PROPERTY DETECTING DEVICE

(71) Applicant: DENSO CORPORATION, (US)

(72) Inventor: Hiroshi Nakamura, Nishio-city (JP)

(73) Assignee: DENSO CORPORATION, Kariya-city (JP)

(21) Appl. No.: 13/766,210

(22) Filed: Feb. 13, 2013

(30) Foreign Application Priority Data
Feb. 17, 2012 (JP) 2012-32470

(51) Int. Cl. G01N 27/00

(52) U.S. Cl. CPC G01N 27/00
USPC 73/31.05

(57) ABSTRACT

A fuel property detecting device includes a passage member, an electrode holding member, a first electrode having a distal end part on a fuel passage-side immersed in fuel in the fuel passage, a second electrode formed radially inward of the first electrode in a tubular shape to extend in an axial direction, spaced away from the first electrode, and having one end part on the fuel passage-side immersed in fuel in the first electrode, an elastic member, and an insulating member. The elastic member is located on the fuel passage-side relative to the holding member to liquid-tightly seal a clearance between the first electrode and the passage member. The insulating member is located on the fuel passage-side relative to the holding member and disposed between the one end part and the other end part of the second electrode to liquid-tightly seal a clearance between the first and second electrodes.

### CROSS REFERENCE TO RELATED APPLICATION

This application is based on Japanese Patent Application No. 2012-32470 filed on Feb. 17, 2012, the disclosure of which is incorporated herein by reference.

### TECHNICAL FIELD

The present disclosure relates to a fuel property detecting device that detects properties of fuel.

### BACKGROUND

Conventionally, there is known a fuel property detecting device that is disposed in a fuel supply system, which supplies fuel to an internal combustion engine, to detect, for example, an alcohol concentration or oxidation state of fuel. A fuel property detecting device described in JP-A-2010-145279 (corresponding to US2010/0156443A1) detects an alcohol concentration of fuel based on a capacitance between a first electrode and a second electrode immersed in fuel in a first housing.

The first electrode is formed in a cylindrical shape, and is inserted in the first housing through an opening of the first housing. The first electrode is pressed against an edge portion of the opening of the first housing in the axial direction. The second electrode is formed in a cylindrical shape, and is inserted in the first electrode. The second electrode is cantilever-supported by an insulating member fixed on an inner wall of the first electrode. A glass seal is employed for the insulating member. The glass seal has resistance to fuel, and has stable electrical temperature characteristics. However, the glass seal has a susceptibility to an impact.

In the fuel property detecting device described in JP-A-2010-145279, the impact applied to the first housing at the time of falling or at the time of collision is transmitted directly to the glass seal via the first electrode. Therefore, there is a concern about a crack in the glass seal due to the above impact.

Moreover, since a proximal end part of the second electrode is cantilever-supported, a distal end part of the second electrode easily vibrates. This vibration is transmitted directly to the glass seal through the proximal end part of the second electrode. Accordingly, there is a concern about a crack in the glass seal caused by the application of overstress because of the above vibration. If the glass seal cracks, fuel leakage will be caused.

### SUMMARY

The present disclosure addresses at least one of the above issues.

According to the present disclosure, there is provided a fuel property detecting device including a passage member, an electrode holding member, a first electrode, a second electrode, an elastic member, and an insulating member. The passage member includes a fuel passage and an opening which communicates with the fuel passage. The electrode holding member is inserted in the opening of the passage member and is fixed to the passage member. The first electrode is formed in a tubular shape to extend from the electrode holding member into the fuel passage and is spaced away from the passage member. The first electrode includes a distal end part on the fuel passage-side immersed in fuel in the fuel passage. The second electrode is formed radially inward of the first electrode in a tubular shape to extend in an axial direction of the first electrode, and is spaced away from the first electrode. The second electrode includes one end part on the fuel passage-side immersed in fuel in the first electrode. The elastic member is located on the fuel passage-side relative to the electrode holding member to liquid-tightly seal a clearance between the first electrode and the passage member. The insulating member is located on the fuel passage-side relative to the electrode holding member and is disposed between the one end part and the other end part of the second electrode to liquid-tightly seal a clearance between the first electrode and the second electrode.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating a configuration of a fuel supply system to which a fuel property detecting device in accordance with an embodiment is applied;

FIG. 2 is a sectional view illustrating the fuel property detecting device in FIG. 1;

FIG. 3 is an enlarged view illustrating an arrow III part in FIG. 2; and

FIG. 4 is a property diagram illustrating a relationship among capacitance between electrodes in the fuel property detecting device in FIG. 2, ethanol concentration of fuel, and temperature of fuel.

### DETAILED DESCRIPTION

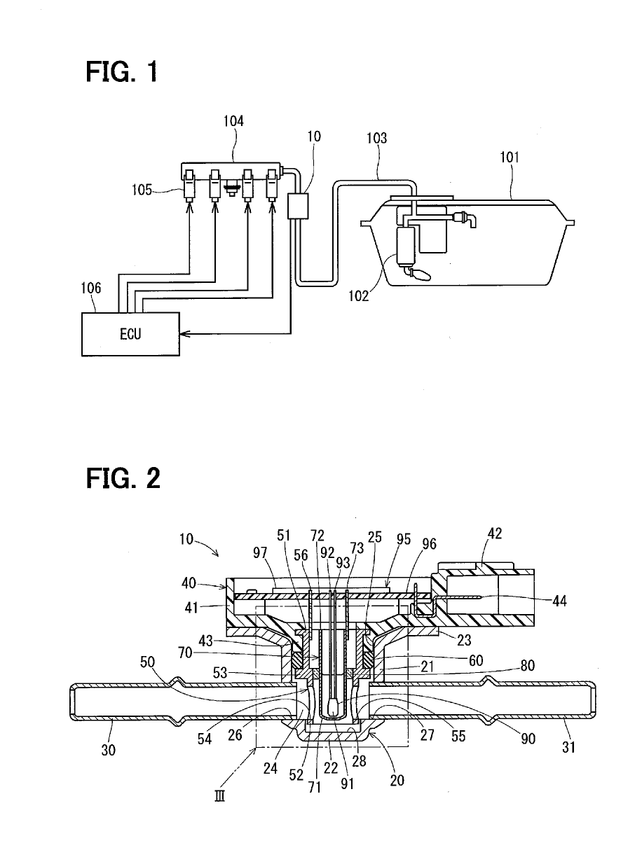

A fuel property detecting device of an embodiment will be described below in reference to the drawings. The fuel property detecting device in the embodiment is used in a fuel supply system for an automobile illustrated in FIG. 1. This fuel supply system is a system for supplying fuel to an engine (not shown), and includes a fuel tank 101, a fuel pump 102, a fuel pipe 103, a delivery pipe 104, an injector 105, and an electrical control unit 106.

The fuel in the fuel tank 101 is pressure-fed into the delivery pipe 104 by the fuel pump 102 through the fuel pipe 103. The fuel in the delivery pipe 104 is injected from the injector 105 into an intake pipe of the engine and into a cylinder of the engine. The electrical control unit 106 controls the operation of the injector 105. A fuel property detecting device 10 is disposed at the fuel pipe 103.

For example, ethanol-blended gasoline in which ethanol and gasoline are mixed together is fed into the fuel tank 101. Ethanol concentration of this ethanol-blended gasoline can be suitably selected in a range of 0 to 100 [%]. Thus, the ethanol concentration of fuel in the fuel tank 101 can change after the time of feeding of gasoline.

The fuel property detecting device 10 detects an ethanol concentration of fuel flowing in the fuel pipe 103. The electrical control unit 106 controls, for example, fuel injection quantity and fuel injection time in accordance with the ethanol concentration detected by the fuel property detecting device 10, so as to operate the engine under its optimum condition. This optimum condition is set in view of, for example, the smallest possible amount of harmful substances in exhaust gas of the engine.

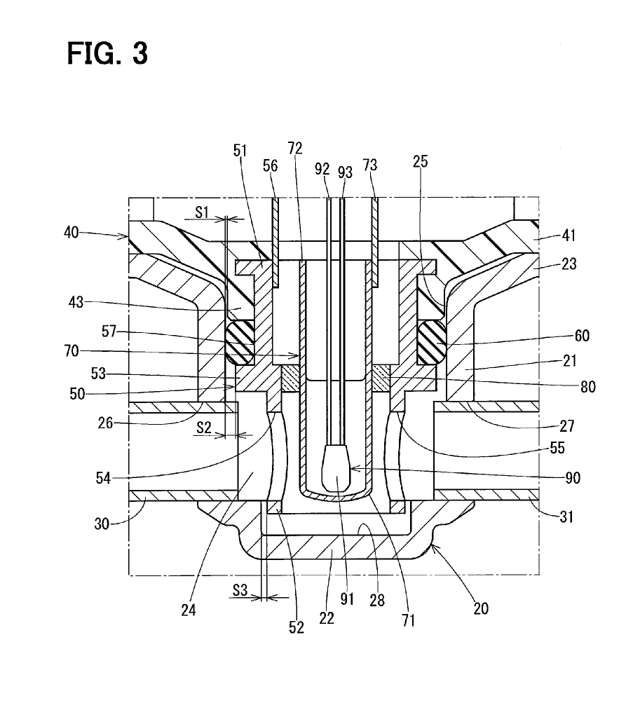

The fuel property detecting device 10 will be explained below with reference to FIGS. 2 and 3. The fuel property detecting device 10 includes a first housing 20, connecting pipes 30, 31, a second housing 40, a first electrode 50, an 0-ring 60, a second electrode 70, a glass seal 80, a thermistor 90, and a circuit part 95.

The first housing 20 may correspond to a “passage member”. The first housing 20 includes a cylindrical part 21 having a fuel passage 24, a bottom part 22 covering one end of the cylindrical part 21, and an attachment part 23 extending radially outward from the other end of the cylindrical part 21 on its opening 25 side.

The cylindrical part 21 includes through holes 26, 27 passing through an end portion of the cylindrical part 21 on the bottom part 22 side. The connecting pipes 30, 31 are fitted in the through holes 26, 27. Clearances between the connecting pipes 30, 31 and the through holes 26, 27 are liquid-tightly sealed.

The connecting pipes 30, 31 can be connected to the fuel pipe 103 in FIG. 1.

The second housing 40 is made of resin, and is constituted integrally of a circuit case part 41, a connector portion 42, and an electrode holding part 43. The electrode holding part 43 may correspond to an “electrode holding member”. The circuit case part 41 is formed into a box shape, and is fixed to the attachment part 23 of the first housing 20. The circuit case part 41 accommodates the circuit part 95.

The connector portion 42 contains terminals 44 which are connected to the circuit part 95. The terminal 44 can connect the circuit part 95 to, for example, the electrical control unit 106 in FIG. 1 or a power source (not shown). The electrode holding part 43 is formed in a cylindrical shape to project from the bottom part of the circuit case part 41 into the first housing 20. The electrode holding part 43 is inserted in the opening 25 of the first housing 20.

The first electrode 50 is formed in a cylindrical shape to extend from the electrode holding part 43 of the second housing 40 into the fuel passage 24. The first electrode 50 is spaced away from the first housing 20. A proximal end part 51 of the first electrode 50 is embedded in the electrode holding part 43. A distal end part 52 of the first electrode 50 is immersed in the fuel in the fuel passage 24. The distal end part 52 includes a pair of through holes 54, 55 that are formed on a flow route from the through hole 26 to the through hole 27 of the first housing 20. A terminal 56 electrically connects together the first electrode 50 and the circuit part 95.

The O-ring 60 may correspond to an “elastic member”. The O-ring 60 is disposed between the first electrode 50 and the cylindrical part 21 of the first housing 20. The O-ring 60 is made of rubber, and liquid-tightly seals an annular clearance between the first electrode 50 and the first housing 20.

The second electrode 70 is formed in a cylindrical shape to extend in an axial direction of the first electrode 50 radially inward of the first electrode 50.

The second electrode 70 is arranged coaxially with the first electrode 50, and is spaced away from the first electrode 50. An end of one end part 71 of the second electrode 70 on the fuel passage 24 side is closed, and the one end part 71 is immersed in fuel in the first electrode 50. A terminal 73 electrically connects together the second electrode 70 and the circuit part 95.

When fuel flows in the fuel passage 24, a space between the first electrode 50 and the second electrode 70 is filled with fuel. As a result, the first electrode 50 and the second electrode 70 constitute a capacitor with the fuel as a dielectric substance.

The glass seal 80 may correspond to an “insulating member”. The glass seal 80 is provided between the first electrode 50 and the second electrode 70. The glass seal 80 is an insulating material having glass as its main component, and liquid-tightly seals an annular clearance between the first electrode 50 and the second electrode 70.

The thermistor 90 includes a resistance 91 and lead wires 92, 93. The resistance 91 has such characteristics that electric resistance varies according to temperature. The resistance 91 is disposed in the one end part 71 of the second electrode 70 which is filled up with a heat conduction material such as heat release grease. The lead wires 92, 93 electrically connect together the resistance 91 and the circuit part 95. The thermistor 90 is a temperature sensor which detects the temperature of fuel in the fuel passage 24.

The circuit part 95 includes a substrate 96 fixed to the circuit case part 41 of the second housing 40, and a concentration calculation part 97 constituted of electronic components on the substrate 96. The concentration calculation part 97 calculates capacitance between the electrodes as a result of charge and discharge between the first electrode 50 and the second electrode 70. The concentration calculation part 97 calculates the temperature of fuel in the fuel passage 24 based on the electric resistance of the thermistor 90.

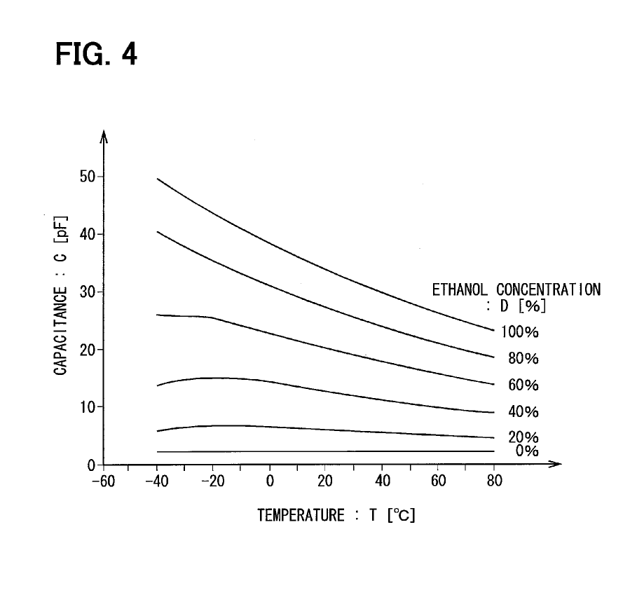

The capacitance between the electrodes changes according to the ethanol concentration of fuel and the temperature of fuel. By use of the above characteristics, the concentration calculation part 97 calculates ethanol concentration D of fuel based on capacitance C between the electrodes and temperature T of fuel from a relationship illustrated in FIG. 4.

The first electrode 50 and the glass seal 80 will be described in more detail in reference to FIG. 3. The glass seal 80 is positioned further on the distal end part 52 side than the O-ring 60 in the axial direction of the first electrode 50. The first electrode 50 includes a flanged part 53 that projects radially outward from a position corresponding to the glass seal 80 in the axial direction. The flanged part 53 defines an annular groove 57, in which the O-ring 60 is fitted, together with the electrode holding part 43 of the second housing 40. The flanged part 53 functions as a slip-off stopping means for preventing a removal of the O-ring 60 toward the fuel passage 24 side.

The glass seal 80 is located midway between the one end part 71 and the other end part 72 of the second electrode 70 in the axial direction. An intermediate part of the second electrode 70 in the axial direction is supported by the glass seal 80. The glass seal 80 serves as a means for fixing the second electrode 70.

The glass seal 80 is melted and adhered between the electrodes under high temperature and is then cooled. Accordingly, the glass seal 80 solidifies with compressive force due to thermal contraction of the first electrode 50 applied to the seal 80. The flanged part 53 is formed by making thick-walled a part of the first electrode 50 that is located radially outward of the glass seal 80.

The flanged part 53 serves as a deformation limiting means for limiting deformation of the first electrode 50 upon application of reactive force from the glass seal 80 in the manufacturing process.

An outer diameter of the flanged part 53 of the first electrode 50 is smaller than an inner diameter of the cylindrical part 21 of the first housing 20. A clearance is formed between the flanged part 53 and the cylindrical part 21. The distal end part 52 of the first electrode 50 is inserted in a recessed part 28 of the bottom part 22 of the first housing 20. A clearance is formed between the distal end part 52 and the bottom part 22.

A radial distance S1 of a clearance between the electrode holding part 43 of the second housing 40 and the first housing 20 is smaller than a radial distance S2 of a clearance between the flanged part 53 of the first electrode 50 and the cylindrical part 21 of the first housing 20. Moreover, the radial distance S1 is smaller than a radial distance S3 of a clearance between the distal end part 52 of the first electrode 50 and the bottom part 22 of the first housing 20.

The O-ring 60 is provided between the first electrode 50 and the first housing 20 in a radially compressed state. Because the first electrode 50 and the first housing 20 have different thermal expansion coefficients from each other, the radial distance of the clearance between the first electrode 50 and the first housing 20 varies according to a temperature change. The O-ring 60 is deformed in accordance with the above change of the radial distance to be constantly in contact with the first electrode 50 and the first housing 20, and the O-ring 60 thereby prevents a leakage of fuel.

As described above, in the fuel property detecting device 10 of the present embodiment, the first electrode 50 is spaced away from the first housing 20. The O-ring 60 which is an elastic body is disposed between the first electrode 50 and the first housing 20.

Accordingly, the impact applied to the first housing 20 at the time of falling of the device 10 or at the time of collision of the device 10 is lessened by the O-ring 60 before it is transmitted to the first electrode 50. The O-ring 60 functions as a buffer material. Thus, a crack of the glass seal 80 caused by the above-described impact can be limited by the O-ring 60. As a result, a fuel leakage due to the break of the glass seal 80 can be limited.

In the present embodiment, the glass seal 80 is provided halfway between the one end part 71 and the other end part 72 of the second electrode 70 to support the second electrode 70. Accordingly, the one end part 71 of the second electrode 70 does not easily vibrate as compared to the case of the other end part being cantilever-held. Thus, a crack of the glass seal 80 caused by this vibration can be limited. As a result, the fuel leakage due to the break of the glass seal 80 can be limited.

In the present embodiment, the first electrode 50 and the second electrode 70 are insulated from each other by the glass seal 80. The glass seal 80 has resistance to fuel, and has stable electrical temperature characteristics. Therefore, the fuel property detecting device 10 has durability and high detection accuracy.

In the present embodiment, the glass seal 80 is located further on the distal end part 52 side than the O-ring 60 in the axial direction of the first electrode 50. The first electrode 50 includes a flanged part 53 that projects radially outward from a position corresponding to the glass seal 80 in the axial direction. Thus, the flanged part 53 prevents a separation of the O-ring 60 toward the fuel passage 24 side. Furthermore, the part of the first electrode 50 that is located radially outward of the glass seal 80 is made thick-walled to form the flanged part 53. Accordingly, the deformation of the first electrode 50 upon application of reactive force from the glass seal 80 in the manufacturing process can be limited.

In the present embodiment, the flanged part 53 of the first electrode 50 and the electrode holding part 43 of the second housing 40 define the annular groove 57, in which the O-ring 60 is fitted. Thus, a groove for the O-ring does not need to be separately provided.

In the present embodiment, the radial distance S1 of the clearance between the electrode holding part 43 of the second housing 40 and the first housing 20 is smaller than the radial distance S2 of the clearance between the flanged part 53 of the first electrode 50 and the cylindrical part 21 of the first housing 20. Moreover, the radial distance S1 is smaller than the radial distance S3 of the clearance between the distal end part 52 of the first electrode 50 and the bottom part 22 of the first housing 20. Consequently, in the case of radial displacement of the electrode holding part 43 relative to the first housing 20, the first electrode 50 and the first housing 20 are not brought into contact; and the electrode holding part 43 and the first housing 20 come into contact. Accordingly, direct transmission of the impact applied to the first housing 20 to the glass seal 80 via the first electrode 50 can be reliably avoided.

Modifications of the above embodiment will be described below. In a modification, the glass seal does not need to be located halfway between the one end part and the other end part of the second electrode. The glass seal only needs to be located between the one end part and the other end part. In a modification, another insulating material may be provided instead of the glass seal. In a modification, another elastic member may be provided instead of the O-ring.

In a modification, the radial distance of the clearance between the first electrode and the first housing may be smaller than the radial distance of the clearance between the first housing and the electrode holding part of the second housing. In a modification, the first electrode does not need to have the flanged part. In a modification, the distal end part of the first electrode does not need to be inserted in the recessed part of the bottom part of the first housing.

In a modification, the fuel property detecting device may detect an alcohol concentration of alcohol-blended gasoline which is a mixture of alcohol other than ethanol, and gasoline. In a modification, the fuel property detecting device may detect another property such as an oxidation state of fuel instead of the alcohol concentration of fuel. In a modification, the fuel property detecting device may detect the ethanol concentration of fuel based on another electrical characteristic such as a resistance value between the electrodes instead of the capacitance between the electrodes.

In a modification, the first electrode and the second electrode only need to have a tubular shape instead of the shape of the circular cylinder. In a modification, the fuel property detecting device may be disposed at another position of the fuel supply system instead of the fuel pipe. The present disclosure is not limited to this embodiment, and can be embodied in various modes without departing from the scope of the disclosure.

To sum up, the fuel property detecting device 10 of the above embodiment can be described as follows.

A fuel property detecting device 10 includes a passage member 20, an electrode holding member 43, a first electrode 50, a second electrode 70, an elastic member 60, and an insulating member 80. The passage member 20 includes a fuel passage 24 and an opening 25 which communicates with the fuel passage 24. The electrode holding member 43 is inserted in the opening 25 of the passage member 20 and is fixed to the passage member 20. The first electrode 50 is formed in a tubular shape to extend from the electrode holding member 43 into the fuel passage 24 and is spaced away from the passage member 20. The first electrode 50 includes a distal end part 52 on the fuel passage 24-side immersed in fuel in the fuel passage 24. The second electrode 70 is formed radially inward of the first electrode 50 in a tubular shape to extend in an axial direction of the first electrode 50, and is spaced away from the first electrode 50. The second electrode 70 includes one end part 71 on the fuel passage 24-side immersed in fuel in the first electrode 50. The elastic member 60 is located on the fuel passage 24-side relative to the electrode holding member 43 to liquid-tightly seal a clearance between the first electrode 50 and the passage member 20. The insulating member 80 is located on the fuel passage 24-side relative to the electrode holding member 43 and is disposed between the one end part 71 and the other end part 72 of the second electrode 70 to liquid-tightly seal a clearance between the first electrode 50 and the second electrode 70.

Accordingly, the impact applied to the passage member 20 at the time of falling of the device 10 or at the time of collision of the device 10 is lessened by the elastic member 60 before it is transmitted to the first electrode 50. The elastic member 60 functions as a buffer material. Thus, a crack of the insulating member 80 caused by the above-described impact can be limited. As a result, a fuel leakage due to the break of the insulating member 80 can be limited.

Moreover, since the second electrode 70 is held between its one end part 71 and other end part 72, the one end part 71 does not easily vibrate as compared to a case of the other end part 72 being cantilever-held. Thus, a crack of the glass seal 80 caused by the above-described vibration can be limited. As a result, a fuel leakage due to the break of the insulating member 80 can be limited.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A fuel property detecting device comprising:
a passage member that includes a fuel passage and an opening which communicates with the fuel passage;
an electrode holding member that is inserted in the opening of the passage member and is fixed to the passage member;
a first electrode that is formed in a tubular shape to extend from the electrode holding member into the fuel passage and is spaced away from the passage member, wherein the first electrode includes a distal end part on the fuel passage-side immersed in fuel in the fuel passage;
a second electrode that is formed radially inward of the first electrode in a tubular shape to extend in an axial direction of the first electrode and that is spaced away from the first electrode, wherein the second electrode includes one end part on the fuel passage-side immersed in fuel in the first electrode;
an elastic member that is located on the fuel passage-side relative to the electrode holding member to liquid-tightly seal a clearance between the first electrode and the passage member; and
an insulating member that is located on the fuel passage-side relative to the electrode holding member and is disposed between the one end part and the other end part of the second electrode to liquid-tightly seal a clearance between the first electrode and the second electrode.

2. The fuel property detecting device according to claim 1, wherein the insulating member is a glass seal.

3. The fuel property detecting device according to claim 1, wherein the insulating member is located halfway between the one end part and the other end part of the second electrode in an axial direction of the second electrode.

4. The fuel property detecting device according to claim 1, wherein:
the insulating member is located further on the distal end part-side than the elastic member in the axial direction; and
the first electrode further includes a flanged part that projects radially outward from a position corresponding to the insulating member in the axial direction.

5. The fuel property detecting device according to claim 4, wherein:
the elastic member is an O-ring; and
the flanged part of the first electrode and the electrode holding member define an annular groove, in which the elastic member is fitted.

6. The fuel property detecting device according to claim 1, wherein a radial distance of a clearance between the passage member and the electrode holding member in the passage member is smaller than a radial distance of the clearance between the first electrode and the passage member.
